(19) United States
(12) Patent Application Publication
(10) Pub. No.: US 2021/0338000 A1
(43) Pub. Date: Nov. 4, 2021

(54) MODULAR SYSTEMS CONFIGURABLE TO ENABLE MULTIPLE METHODS FOR PRODUCING EDIBLE EXTRACTIONS

(71) Applicant: Omri Almagor, Milano (IT)

(72) Inventor: Omri Almagor, Milano (IT)

(21) Appl. No.: 17/246,709

(22) Filed: May 2, 2021

Related U.S. Application Data
(60) Provisional application No. 63/019,539, filed on May 4, 2020.

(51) Int. Cl. A47J 31/00; A47J 31/06; A47J 31/02

(52) U.S. Cl. CPC A47J 31/005; A47J 31/02; A47J 31/06

(57) ABSTRACT

Embodiments of systems having various configurations to enable several methods to produce different consumable extractions by processing at least partially soluble material(s) via solvent(s), including beverages. Other embodiments may be described and claimed.

### TECHNICAL FIELD

Various embodiments described herein relate generally to producing consumable extractions by processing at least partially soluble material(s) via solvent(s), including systems and methods for producing liquid extracts such as beverages.

### BACKGROUND INFORMATION

It may be desirable to provide systems that enable multiple methods for processing at least partially soluble material(s) via solvent(s) to produce consumable extractions via a compact, portable, and configurable system; the present invention provides such systems and methods.

### BRIEF DESCRIPTION OF THE DRAWINGS

FIG. 1A is a simplified side view diagram of a compact, portable modular system that may be configurable to enable multiple methods to produce consumable extractions from at least partially soluble material(s) via a solvent according to various embodiments.

FIG. 1B is a simplified top view diagram of the modular system shown in FIG. 1A without some components according to various embodiments.

FIG. 1C is a simplified bottom view image of the modular system shown in FIG. 1A without some components according to various embodiments.

FIG. 1D is an exploded side view of the modular system as shown in FIG. 1A according to various embodiments.

FIG. 2A is a simplified side view diagram of another compact, portable modular system that may be configurable to enable multiple methods to produce consumable extractions from at least partially soluble material(s) via a solvent according to various embodiments.

FIG. 2B is a simplified top view diagram of the modular system shown in FIG. 2A according to various embodiments.

FIG. 2C is a simplified bottom view image of the modular system shown in FIG. 2A according to various embodiments.

FIG. 2D is a simplified isometric view diagram of the modular system shown in FIG. 2A according to various embodiments.

FIG. 2E is a simplified cross-sectional view diagram of the modular system shown in FIG. 2A according to various embodiments.

FIG. 2F is a simplified isometric exploded view diagram of all components of the modular system shown in FIG. 2A according to various embodiments.

FIG. 3A is a simplified isometric view diagram of the compact, portable modular system with various components coupled together to enable first methods to produce consumable extractions from at least partially soluble material(s) via a solvent according to various embodiments.

FIG. 3B is a simplified isometric cross-sectional view diagram of the modular system with various components coupled together as shown in FIG. 3A according to various embodiments.

FIG. 3C is a simplified isometric exploded view diagram of the modular system with various components as shown in FIG. 3A according to various embodiments.

FIG. 4A is a simplified isometric view diagram of the compact, portable modular system with various components coupled together to enable second methods to produce consumable extractions from at least partially soluble material(s) via a solvent according to various embodiments.

FIG. 4B is a simplified isometric cross-sectional view diagram of the modular system with various components coupled together as shown in FIG. 4A according to various embodiments.

FIG. 4C is a simplified isometric exploded view diagram of the modular system with various components as shown in FIG. 4A according to various embodiments.

FIG. 4D is a simplified isometric cross-sectional view diagram of the modular system shown in FIG. 4A with an additional component according to various embodiments.

FIG. 5A is a simplified isometric view diagram of the compact, portable modular system with various components coupled together to enable third methods to produce consumable extractions from at least partially soluble material(s) via a solvent according to various embodiments.

FIG. 5B is a simplified isometric cross-sectional view diagram of the modular system with various components coupled together as shown in FIG. 5A according to various embodiments.

FIG. 5C is a simplified isometric exploded view diagram of the modular system with various components as shown in FIG. 5A according to various embodiments.

FIG. 5D is a simplified isometric cross-sectional view diagram of the modular system shown in FIG. 5A with a component removed according to various embodiments.

FIG. 6A is a simplified isometric view diagram of the compact, portable modular system with various components coupled together to enable fourth methods to produce consumable extractions from at least partially soluble material(s) via a solvent according to various embodiments.

FIG. 6B is a simplified isometric cross-sectional view diagram of the modular system with various components coupled together as shown in FIG. 6A according to various embodiments.

FIG. 6C is a simplified isometric exploded view diagram of the modular system with various components as shown in FIG. 6A according to various embodiments.

FIG. 6D is a simplified isometric cross-sectional view diagram of the modular system shown in FIG. 6A with an additional component according to various embodiments.

FIG. 7 is a simplified isometric cross-sectional view diagram of the modular system shown in FIG. 6A with a component removed according to various embodiments.

FIG. 8A is a simplified isometric view diagram of a main body component of the modular system according to various embodiments.

FIG. 8B is a simplified enlarged view of area AA shown in FIG. 8A according to various embodiments.

FIG. 9A is a simplified isometric view diagram of a spacer component of the modular system according to various embodiments.

FIG. 9B is a simplified lower isometric view diagram of the spacer component shown in FIG. 9A according to various embodiments.

FIG. 10A is a simplified isometric view diagram of a nozzle component of the modular system according to various embodiments.

FIG. 10B is a simplified lower isometric view diagram of the nozzle component shown in FIG. 10A according to various embodiments.

FIG. 11A is a simplified isometric view diagram of a flat bottom component of the modular system according to various embodiments.

FIG. 11B is a simplified lower isometric view diagram of the flat bottom component shown in FIG. 11A according to various embodiments.

### DETAILED DESCRIPTION

The present invention provides portable, compact modular systems that can be configured to enable various methods to produce desired extractions of substances from materials via the application of solvent(s) via gravity. In an embodiment, a system includes several components that may coupled in different configurations to form a modular, compact system that may produce a solution from a solute material via the application of a solvent for an individual's consumption. Each resultant modular system may be sized to be placed over a container to both receive the solution and enable an individual to drink the solution such as a beverage cup or mug in an embodiment. Several components of many of a system may be coupled to enable an individual or user to employ different method(s) to produce a desired solution.

In an embodiment, several components of the modular system 100A, 100B may be coupled together to form configurations that have a chamber or area 5 where solvent and solute material may be processed. The configuration(s) may also have an entry area 6 where solvent (in various states of matter) may be introduced to reach a chamber 5. In some configurations, solute material such as coffee grounds, tea, or other soluble, edible material may be placed in the chamber 5 prior to the introduction of a solvent into area 6. In particular, modular compact systems 100A, 100B may include components that may be coupled into different configurations 100C-J to enable a user or individual to form solutions via different methods. In an embodiment, the solvent may include water and the soluble material may include an at least partially soluble material such as coffee beans, teas, or other plant material to produce substance(s) that are desirable in water such as oils, acids, organic molecules, caffeine and other substances.

For example, coffee beans or seeds that are harvested from coffee berries may be ground to form a soluble material. The resultant ground coffee beans may be “brewed” by applying a solvent—water to the ground to create coffee. There are many methods for producing coffee from coffee grounds. In each, the ground coffee beans are mixed with water (hot or cold) long enough to form desirable soluble suspended substances from the bean but not so long that other undesirable soluble substances are released, such as bitter compounds. The resultant aqueous solution is ideally separated from the ground coffee beans. Factors for processing coffee grounds include the granularity of the material (fineness of grounds), ratio of solvent to material (water to coffee bean grounds), and the technique used to separate the aqueous solution and the processed materials (grounds).

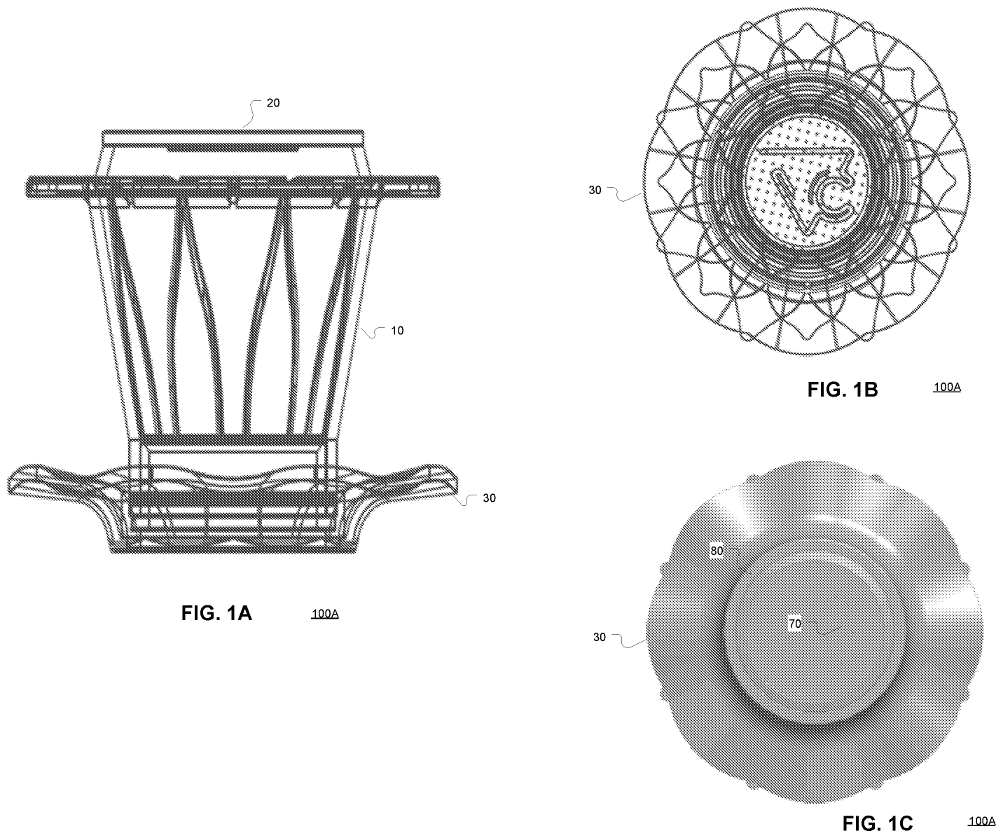

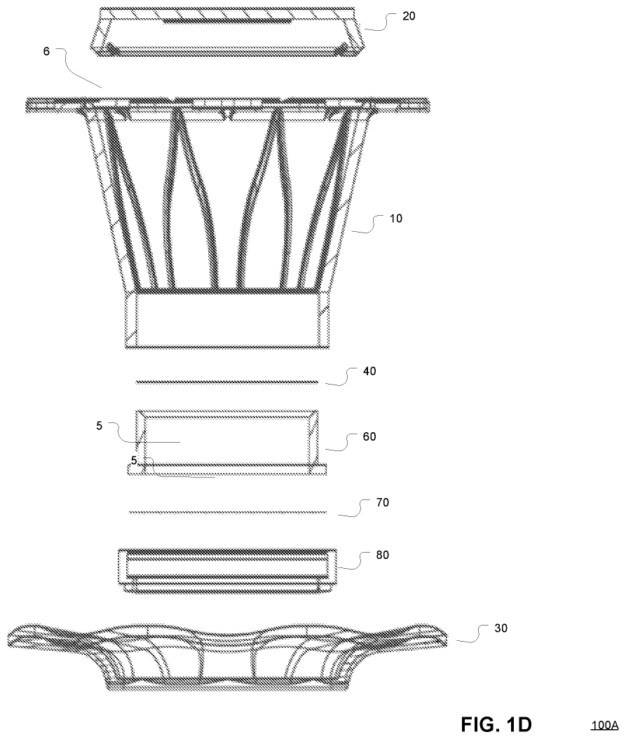

In an embodiment, components of the modular system 100A, 100B may be coupled together to form different configurations to enable a user to produce many different types of coffee beverages. FIGS. 1A-1D show a first compact, portable modular system 100A according to various embodiments. FIG. 1A is a simplified side view diagram of the modular system 100A. FIG. 1B is a simplified top view diagram of the modular system 100A shown in FIG. 1A without some components according to various embodiments. FIG. 1C is a simplified bottom view image of the modular system 100A shown in FIG. 1A without some components according to various embodiments. FIG. 1D is an exploded side view of the modular system 100A as shown in FIG. 1A showing the components available to form various configurations according to various embodiments.

As shown in FIGS. 1A-1D, the modular system 100A components include a main body 10, a lid 20, a support 30, an upper filter 40, a spacer or material chamber 60, a lower filter 70, a sealing gasket or member 80. In an embodiment, the support 30 may be sized so it can be placed over a solution receiving container such a coffee cup, mug, or other container and have a central opening to allow liquid to pass therethrough. The lid 20 may be shaped and sized to rest over the main body 10 top to limit temperature changes of a solvent placed into the main body 10 via entrance or area 6 in a configuration.

In an embodiment, the upper filter 40 may be inserted or nested into the main body 10 bottom and held there via the spacer or chamber 60 when employed in a configuration. In an embodiment, the lower filter 70 may be inserted or nested below the spacer or chamber 60 bottom and held there via the gasket 80 when employed in a configuration. The gasket 80 may be sized to be placed over the spacer 60, filter 70 (when employed in a configuration) and the bottom of the main body 10 to prevent solution or solvent from escaping from the main body other than where desired. Accordingly, a chamber 5 may be formed when the spacer 60, upper filter 40, and lower filter 70 are coupled together in an embodiment where the solute material such as coffee grounds may inserted therein. Solution such as water may be inserted into the main body 10 via entry 6. The lower filter 70 or upper filter 40 may be removed in other configurations, such as configuration where the solute material mixes with the solvent in the main body 10.

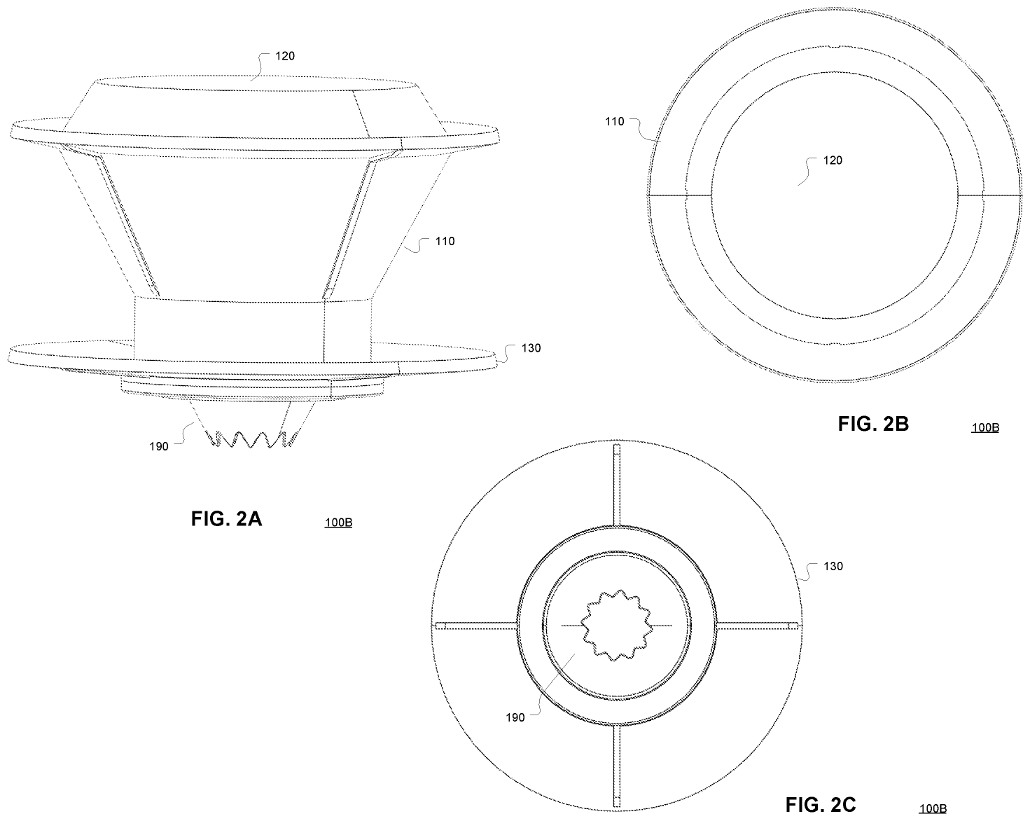

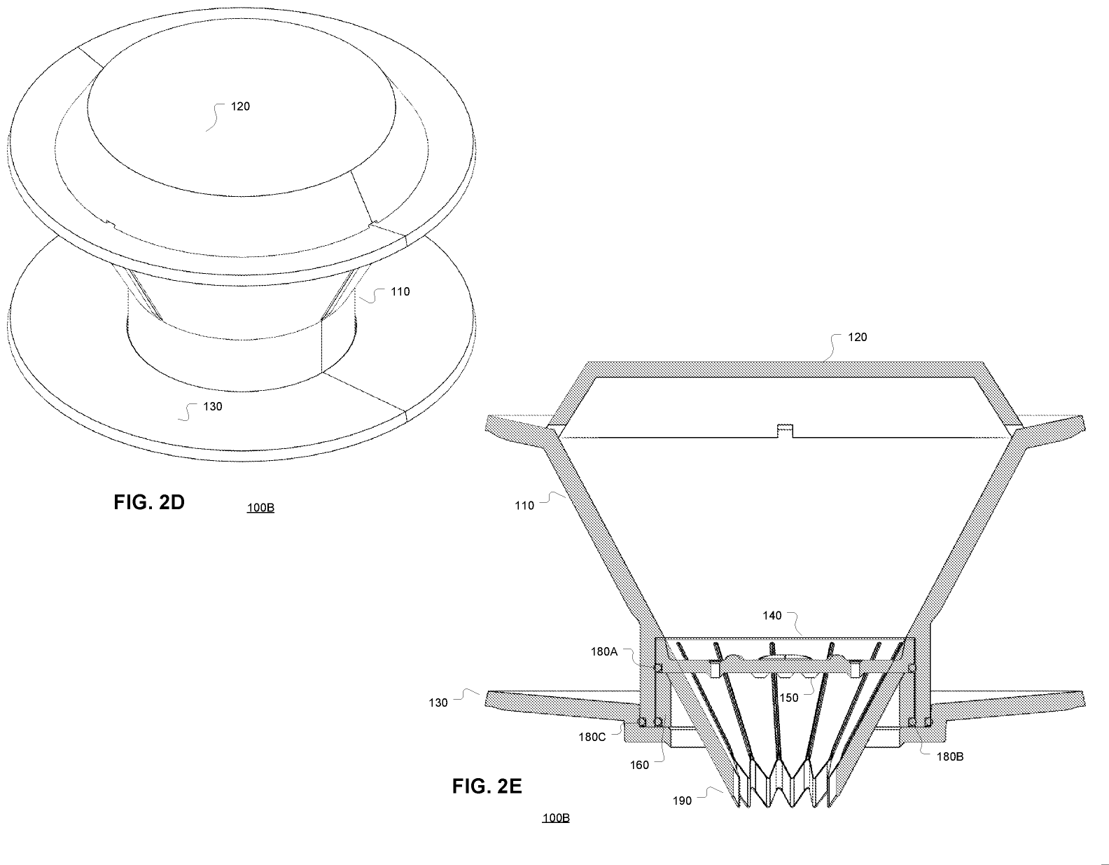

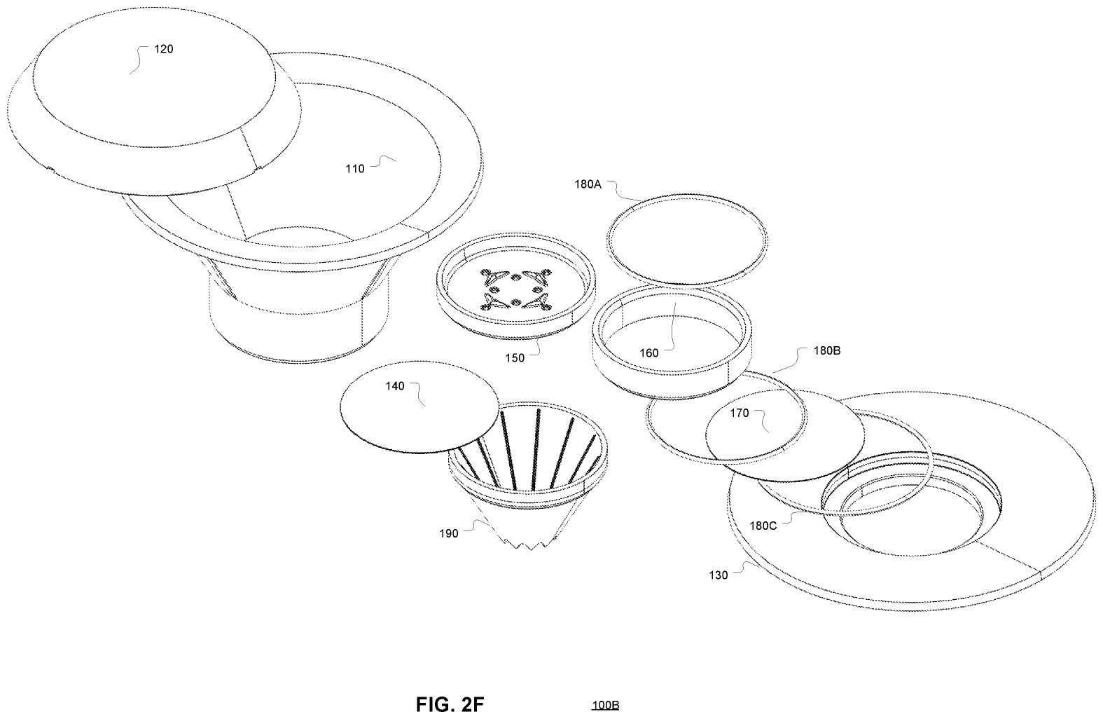

FIGS. 2A-2F show a second compact, portable modular system 100B similar to system 100A according to various embodiments. FIG. 2A is a simplified side view diagram of the modular system 100B. FIG. 2B is a simplified top view diagram of the modular system 100B shown in FIG. 2A according to various embodiments. FIG. 2C is a simplified bottom view image of the modular system 100B shown in FIG. 2A according to various embodiments. FIG. 2D is a simplified isometric view diagram of the modular system 100B shown in FIG. 2A according to various embodiments. FIG. 2E is a simplified cross-sectional view diagram 100B of the modular system shown in FIG. 2A according to various embodiments. FIG. 2F is a simplified isometric exploded view diagram of all components of the modular system 100B shown in FIG. 2A according to various embodiments.

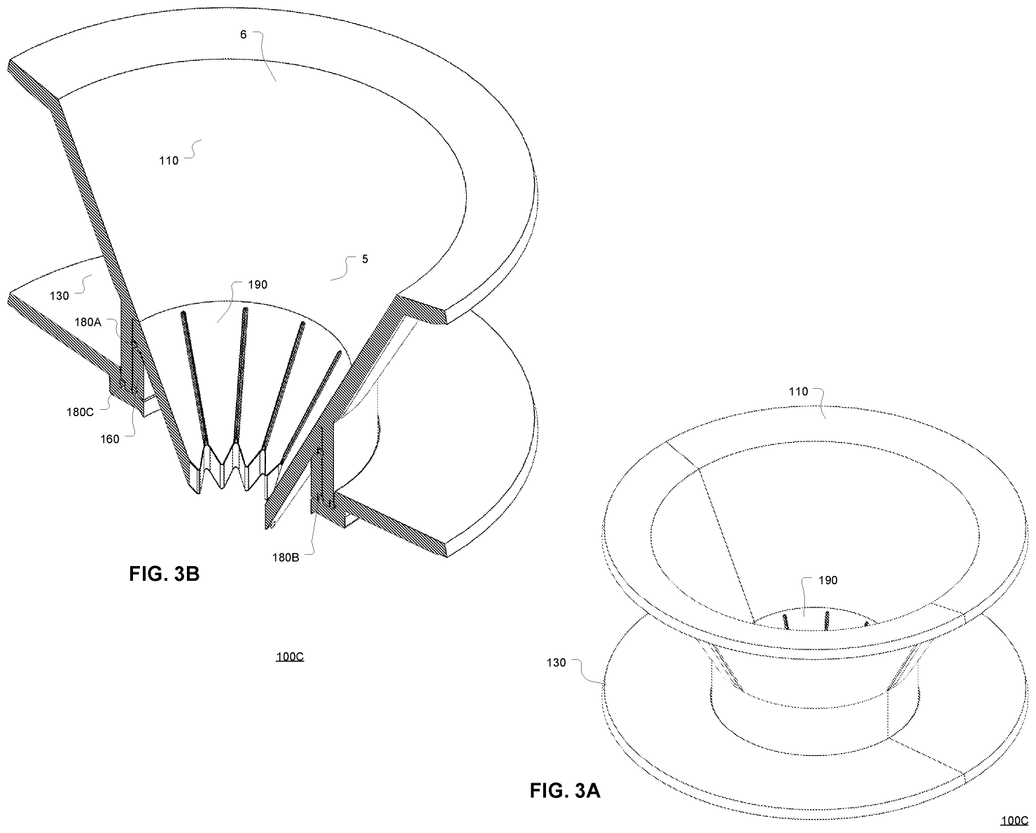

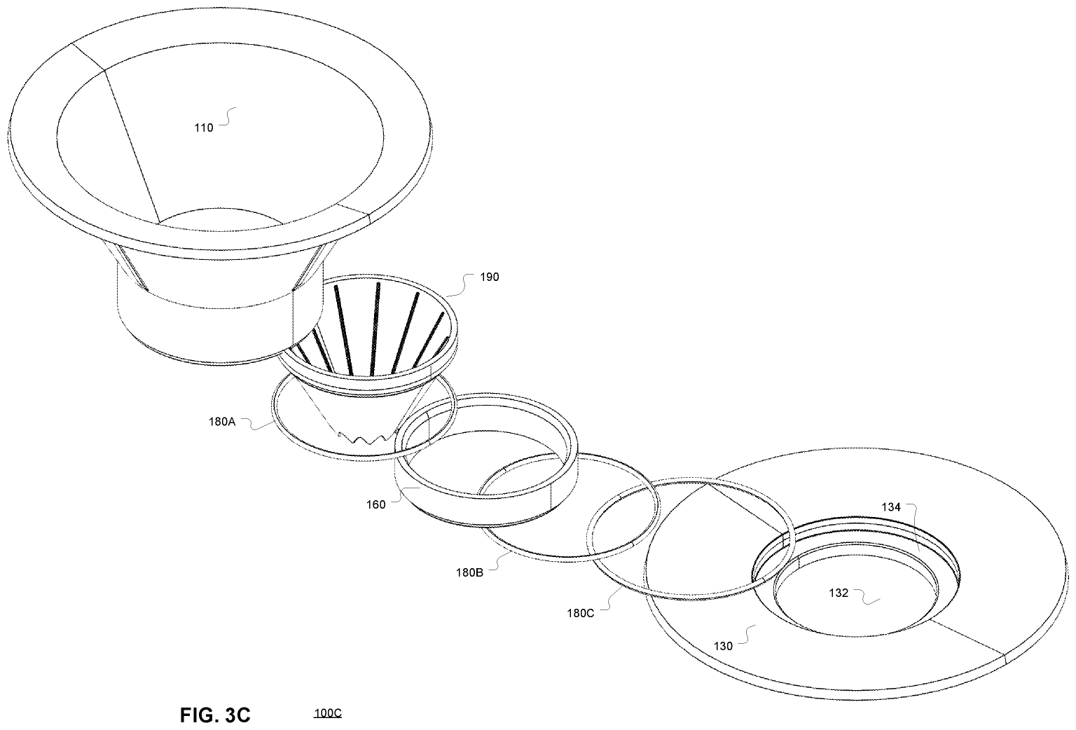

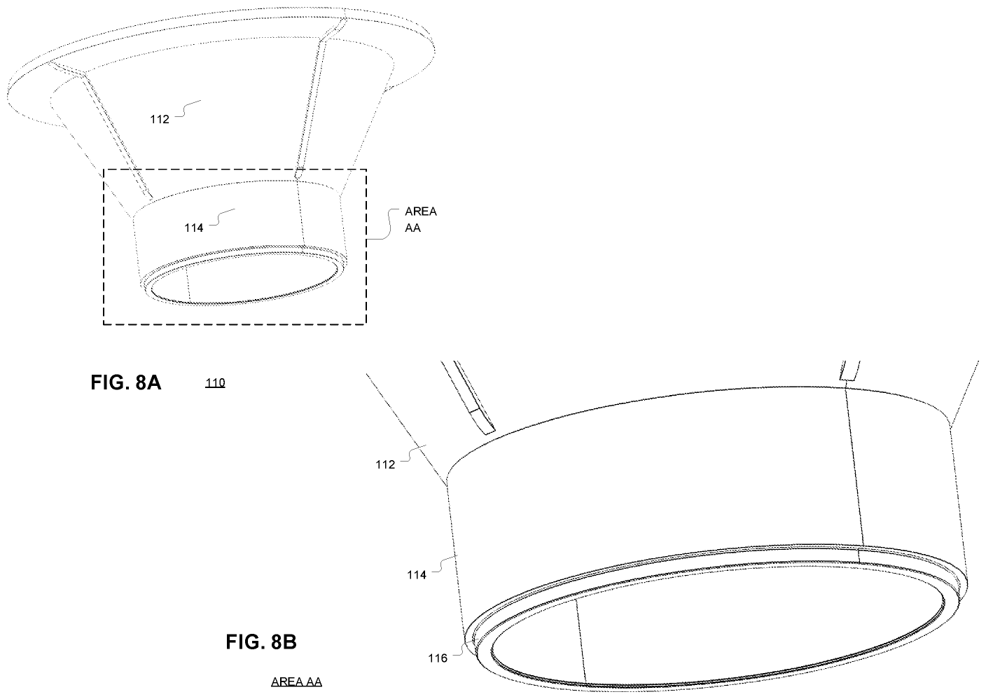

As shown in FIGS. 2A-2F, the modular system 100B components include a main body 110, a lid 120, a support 130, an upper filter 140, a spacer-support 150, a support-material chamber 160, a lower filter 170, a vent-cone filter adapter 190, and O-rings 180A-C. Various components 110-190 of the modular system 100B may be coupled together to form different configuration 100C-J shown in FIGS. 3A-7. The components 110-190 are shaped to enable their coupling and sealing via the O-rings 180A-C to form the configurations 110-190 as shown in FIGS. 8A-11B.

FIG. 8A is a simplified isometric view diagram of a main body component 110 of the modular system 100B according to various embodiments. FIG. 8B is a simplified enlarged view of area AA of the main body 110 shown in FIG. 8A according to various embodiments. As shown in FIGS. 8A-8B, the main body 110 may include an elongated, narrowing conical cylindrical section 112, and a bottom straight cylindrical section 114. The bottom cylindrical section 114 may have a diameter sized to fit securely into opening 134 of the support 130 (shown in FIG. 3C). As shown in FIG. 8B, the cylindrical section 114 may include an inset 116 at its distal end. The inset 116 may be sized to engage the larger O-ring 180C. The inner diameter of the cylindrical section 114 may be sized to enable the remaining components of the modular system 100B to nest at least partially therein.

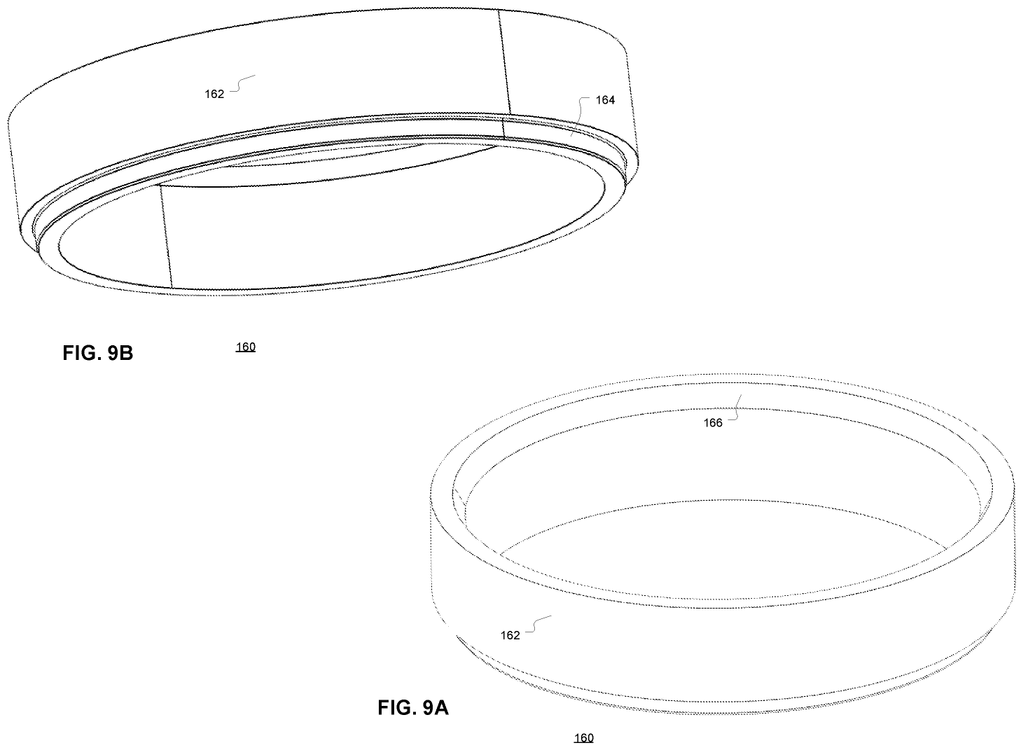

FIG. 9A is a simplified isometric view diagram of a support-material chamber 160 of the modular system 100B according to various embodiments. FIG. 9B is a simplified lower isometric view diagram of the support-material chamber 160 shown in FIG. 9A according to various embodiments. As shown in FIGS. 9A-9B, the component 160 includes a cylindrical section 162 having a diameter enabling it to securely pass into the section 114 of the main body 110. As also shown in FIGS. 9A-9B, the lower portion of the cylindrical section 162 may include an inset sized to nest-engage one of the other two cylindrical O-rings 180A-B. The inner, upper section of the cylindrical section 162 may include a slanted portion 166 to engage the sides of the vent or nozzle component 190 when coupled thereto.

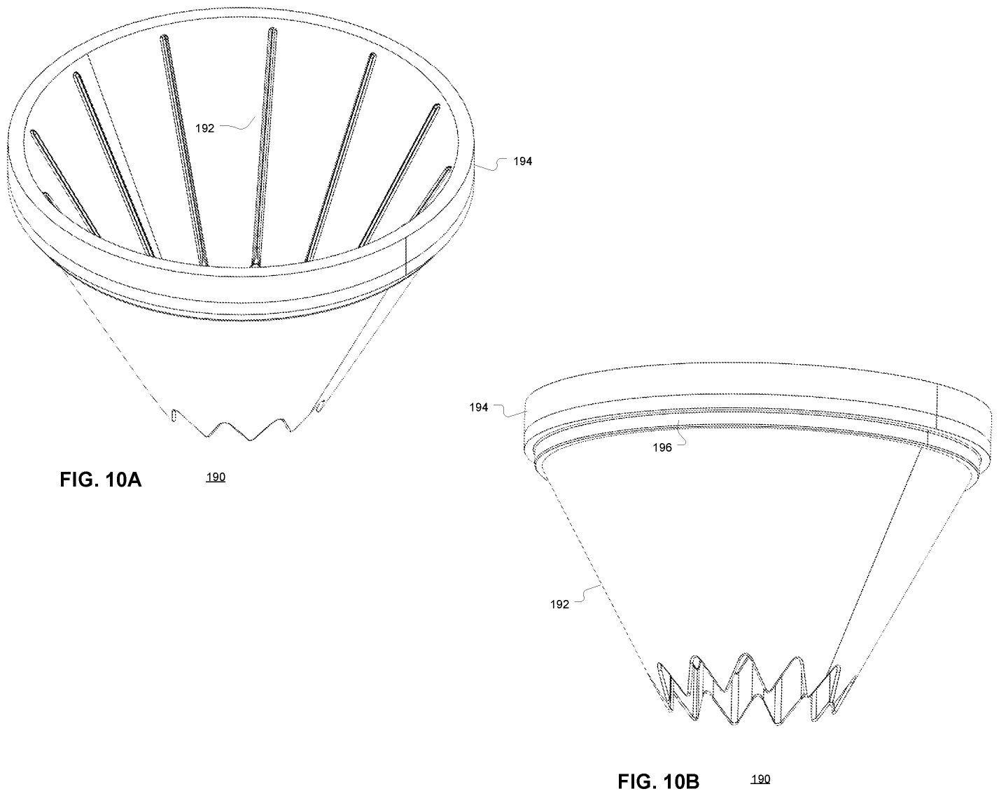

FIG. 10A is a simplified isometric view diagram of a vent or nozzle component 190 of the modular system 100B according to various embodiments. FIG. 10B is a simplified lower isometric view diagram of the vent or nozzle component 190 shown in FIG. 10A according to various embodiments. As shown in FIGS. 10A-10B, the nozzle includes a narrowing conical cylindrical section 192 with an upper straight cylindrical section 194. The upper section 194 has a diameter smaller than the inner diameter of section 114 of the main body. The upper section 194 also has an inset 196 sized to nest-engage one of the other two cylindrical O-rings 180A-B.

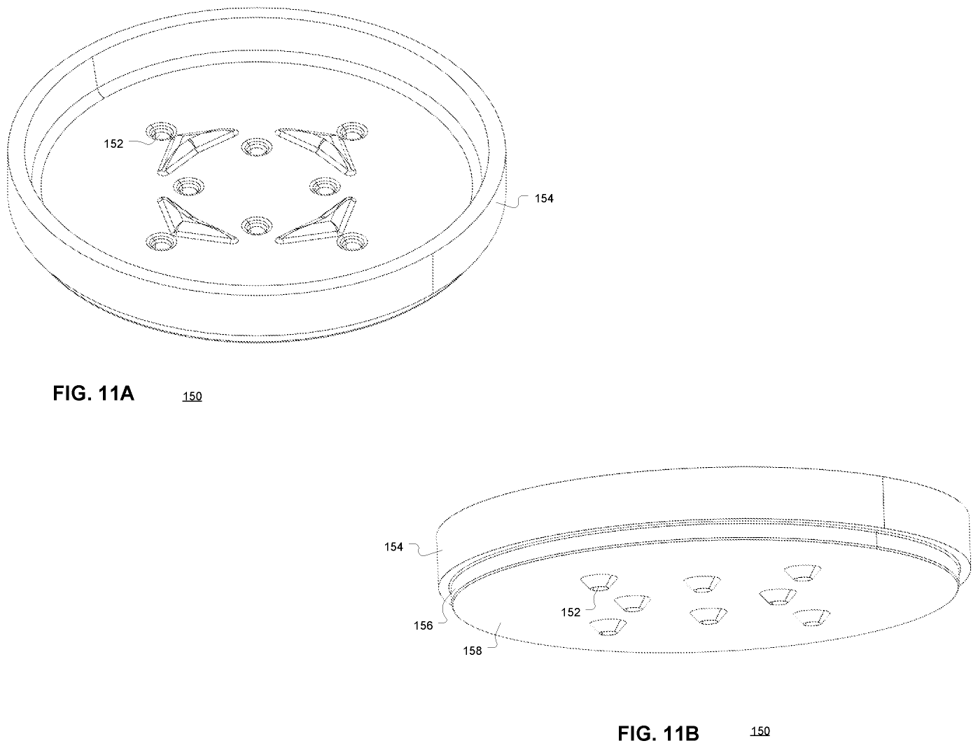

FIG. 11A is a simplified isometric view diagram of a flat bottom-spacer component 150 of the modular system 100B according to various embodiments. FIG. 11B is a simplified lower isometric view diagram of the flat bottom component 150 shown in FIG. 11A according to various embodiments. As shown in FIGS. 11A-11B, the component 150 includes a straight cylindrical section 154. The cylindrical section 154 has a diameter smaller than the inner diameter of section 114 of the main body. The cylindrical section 154 also has an inset 156 sized to nest-engage one of the other two cylindrical O-rings 180A-B. The flat bottom-spacer component 150 also includes a base 158 having several opening 152 to enable liquid to pass therethrough.

Several components 110-190 of modular system 100B may be coupled together to form various configurations or embodiments such as embodiments 100C-J shown in FIGS. 3A-7 to produce different solutions via solvents and soluble materials. In an embodiment, the components 110-130, 150, 160, 180, and 190 may be formed of a polymer, plastic, EPDM, ceramic, metals, or metal alloys. The filters 140, 170 may be formed of a metal or metal alloy including stainless steel. The filter 140, 170 may include from 100 to 900 openings. In an embodiment, a filter 140 may have less openings, thus larger openings than the filter 170. The filters 140, 170 may have similar diameters and be interchangeable in position in a configuration 100C-J of the modular system 100B. The O-rings may be formed of a flexible, resilient material such as a polymer, silicon, EPDM, natural rubber, or combinations thereof.

As noted, various configurations 100C-J of the modular system 100B may formed from its components 110-190. FIGS. 3A-3C are diagrams of a configuration 100C of the modular system 100B with various components coupled together to enable first methods to produce consumable extractions from at least partially soluble material(s) via a solvent according to various embodiments. FIG. 3A is a simplified isometric view diagram of the modular system 100B configuration 100C. FIG. 3B is a simplified isometric cross-sectional view diagram of the modular system 100B configuration 100C with various components coupled together as shown in FIG. 3A according to various embodiments. FIG. 3C is a simplified isometric exploded view diagram of the modular system 100B configuration 100C with various components as shown in FIG. 3A according to various embodiments.

As shown in FIGS. 3A-3C, configuration 100C includes the main body 110, the nozzle 190, the support 130, the spacer-chamber 160, and O-rings 180A-C coupled together. To form this configuration 100C, the spacer 160 and lower ring 180B (to engage inset 164) may be placed into inset 134 of the support 130. A second ring 180A may be placed under the nozzle 190 (to engage inset 196) and the nozzle inserted into the spacer 160. The side wall 192 of the nozzle 190 may engage or nest along the slant 166 of the spacer 160. Then the larger ring 180C may engage the inset 116 of the main body 110 and the main body section 114 may be inserted over the nozzle 190 and spacer 160 and securely engage the inset 134 of the support 130. This configuration may be used to hold a cylindrically shaped filter that may be inserted into the opening 6 formed by the configuration 100C such as a V60 #2 filter which has a length of 8.5 cm and largest upper diagram of 11.5 cm. A solute material may then be inserted into the filter to rest in the chamber 5. A solvent may then be poured into the opening 6 to allow solution to exit from the nozzle 190.

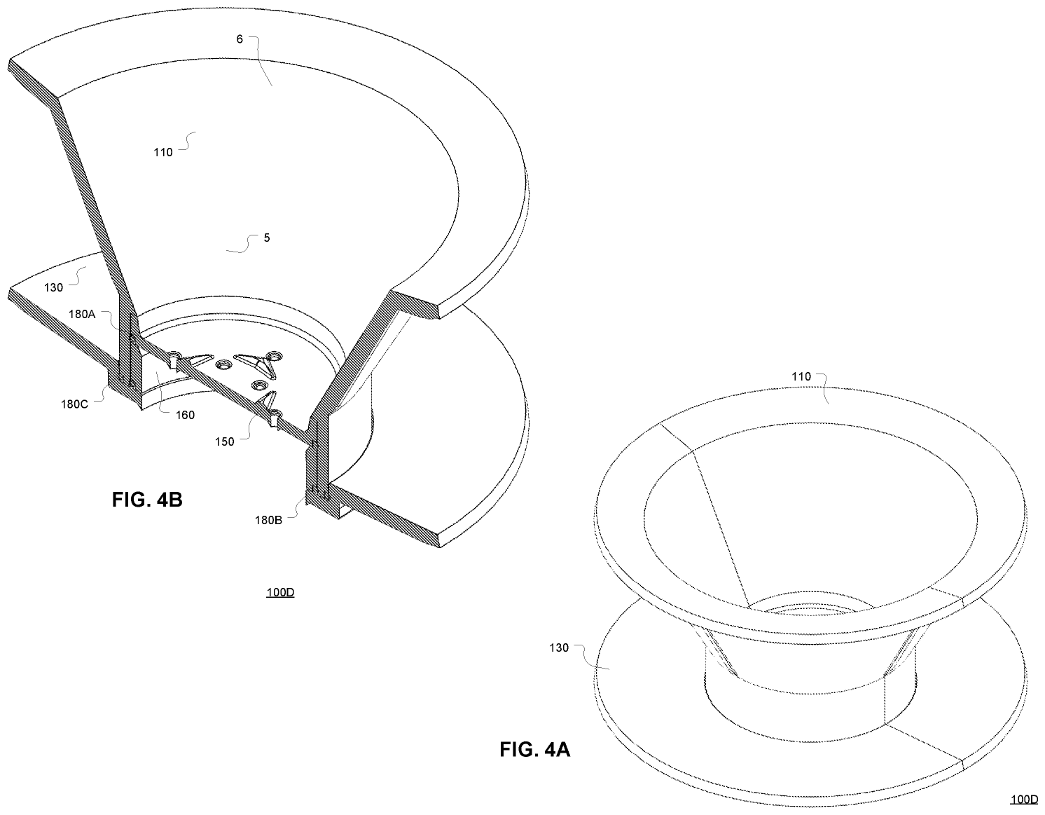

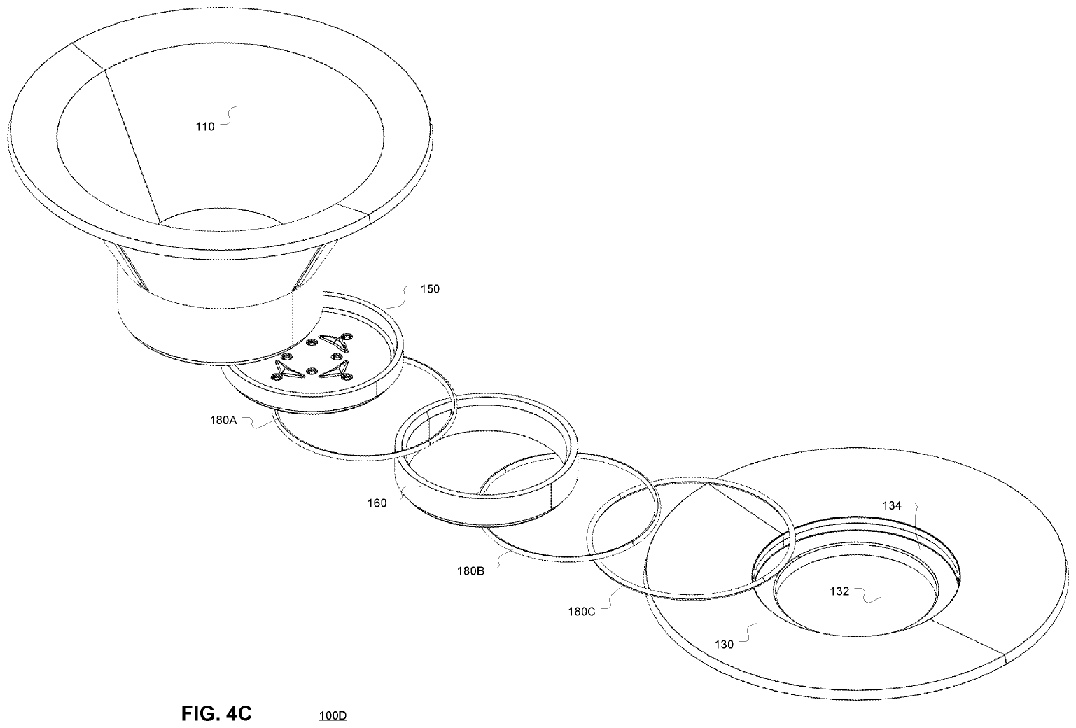

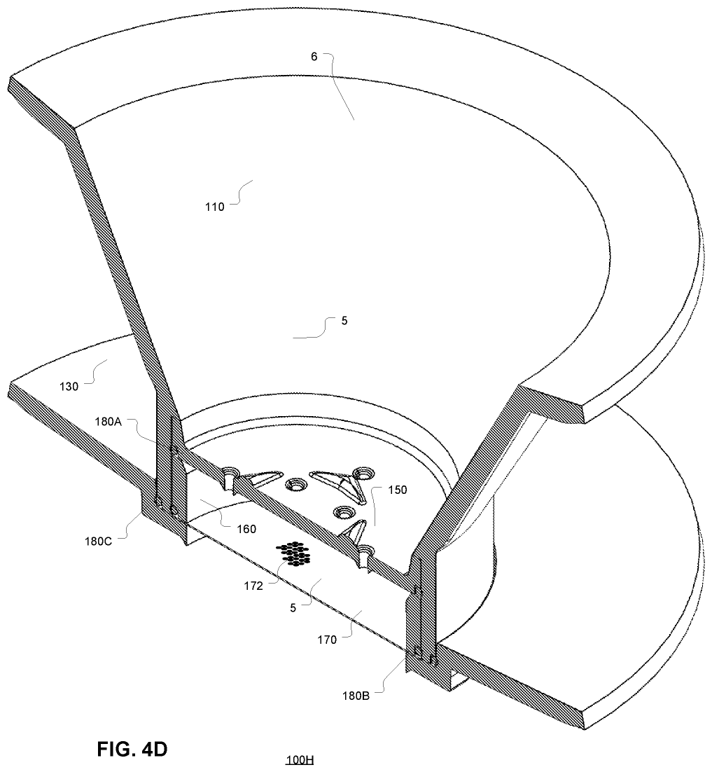

FIGS. 4A-4C are diagrams of a configuration 100D of the modular system 100B with various components coupled together to enable second methods to produce consumable extractions from at least partially soluble material(s) via a solvent according to various embodiments. FIG. 4A is a simplified isometric view diagram of the modular system 100B configuration 100D. FIG. 4B is a simplified isometric cross-sectional view diagram of the modular system 100B configuration 100D. FIG. 4C is a simplified isometric exploded view diagram of the modular system 100B configuration 100D.

As shown in FIGS. 4A-4C, configuration 100D includes the main body 110, the support 130, the flat bottom spacer 150, the spacer 160, and O-rings 180A-C. Configuration 100D is similar to configuration 100C other than exchanging the nozzle component 160 with the flat bottom spacer component 150. This configuration may be used to hold a cylindrically flat-bottomed shaped filter that may be inserted into the opening 6 formed by the configuration 100D such as a Kalita (r) number 102 filter having a width of 11 cm. A solute material may then be inserted into the flat-bottomed filter to rest in the chamber 5. A solvent may then be poured into the opening 6 to allow solution to exit from the flat-bottomed spacer 150 openings 152. In an embodiment, ice may be placed in the chamber 5 and allowed to melt, where resultant liquid passes through the openings 152.

FIG. 4D is a simplified isometric view diagram of a configuration 100H of the modular system 100B with various components coupled together to enable methods to produce consumable extractions from at least partially soluble material(s) via a solvent according to various embodiments. Configuration 100H is similar to configuration 100D other than the addition of the filter 170 inserted in the bottom of the main body 110 creating the chamber 5 where a user can insert solute material such as coffee grounds. Then a solvent of various states may be inserted into the main body 110 via entry 6. In an embodiment, ice may be placed in the main body and coffee grounds in the chamber 5 so iced coffee may be produced by the configuration 100H.

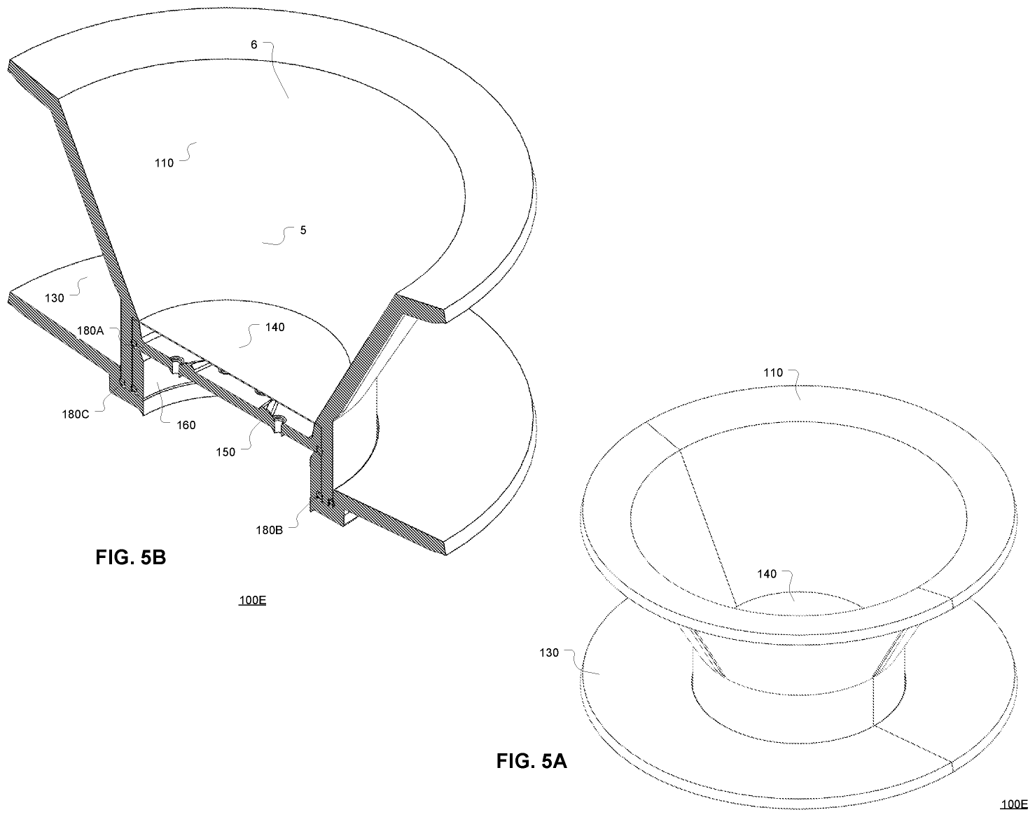

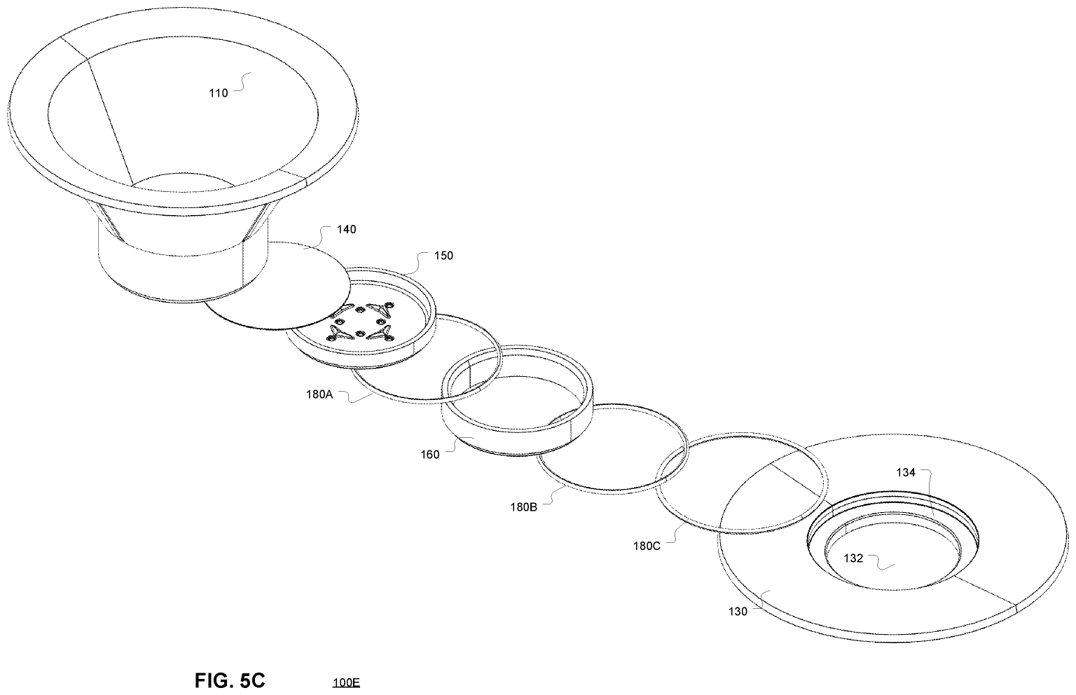

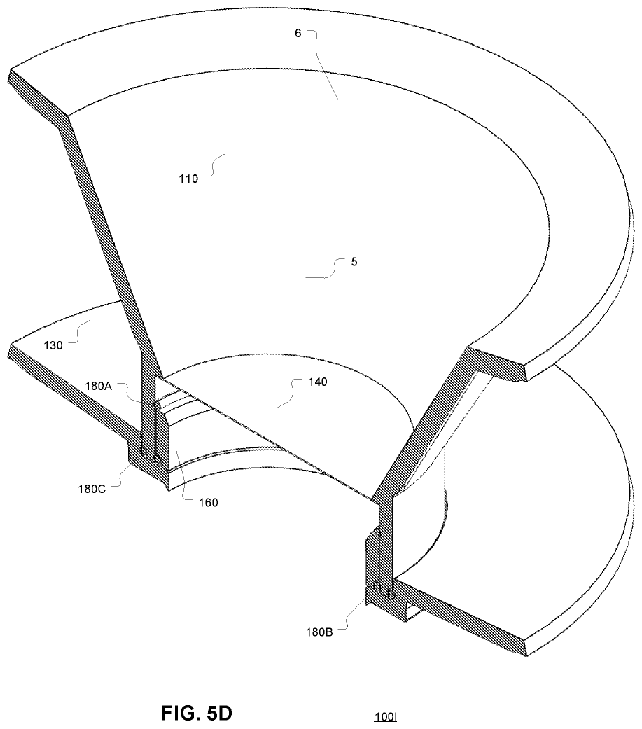

FIGS. 5A-5C are diagrams of a configuration 100E of the modular system 100B with various components coupled together to enable methods to produce consumable extractions from at least partially soluble material(s) via a solvent according to various embodiments. FIG. 5A is a simplified isometric view diagram of the modular system 100B configuration 100E. FIG. 5B is a simplified isometric cross-sectional view diagram of the modular system 100B configuration 100E. FIG. 5C is a simplified isometric exploded view diagram of the modular system 100B configuration 100E.

As shown in FIGS. 5A-5C, configuration 100E includes the main body 110, the support 130, the flat bottom spacer 150, the spacer 160, the upper or lower filter 140, 170, and O-rings 180A-C. Configuration 100E is similar to configuration 100E other than the addition of the filter 140 or 170 above the flat bottom spacer component 150. A solute material may then be inserted into the chamber 5 to rest against the filter 140 or 170. A larger pore 142 or smaller pore 172 filter 140, 170 may be selected as a function of the solute material size and time that solvent should process solute material. A solvent may then be poured into the opening 6 to allow solution to exit from the flat-bottomed spacer 150 openings 152 via the selected filter 140 or 170. Such a configuration may be used to brew Turkish or other coffee where the grounds are left to float in the solvent during processing.

FIG. 5D is a simplified isometric view diagram of a configuration 100I of the modular system 100B with various components coupled together to enable methods to produce consumable extractions from at least partially soluble material(s) via a solvent according to various embodiments. Configuration 100I is similar to configuration 100E other than the removal of the flat bottom spacer component 150.

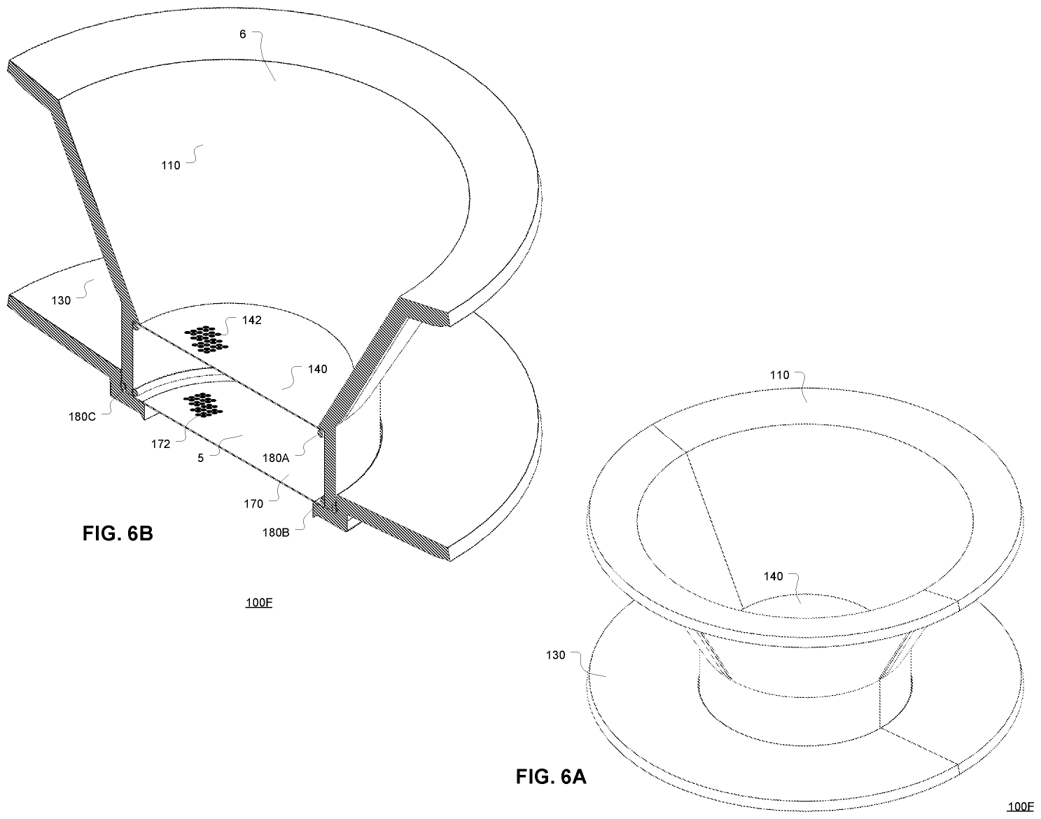

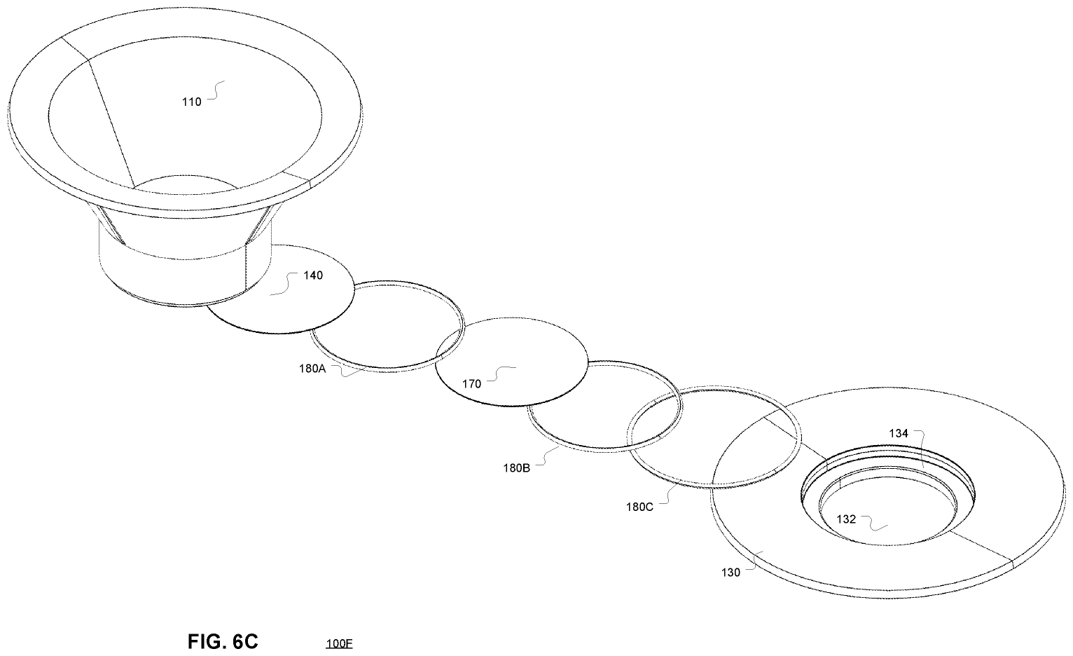

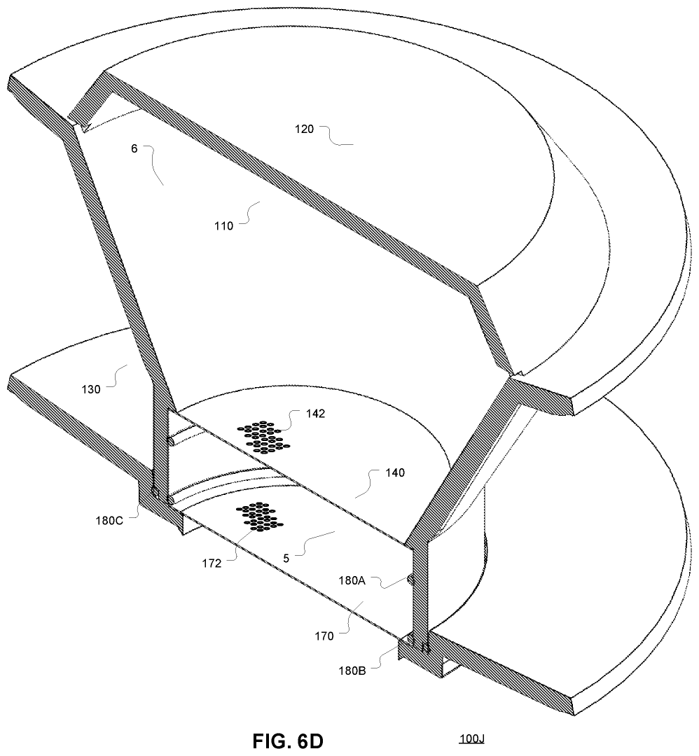

FIGS. 6A-6C are diagrams of a configuration 100F of the modular system 100B with various components coupled together to enable methods to produce consumable extractions from at least partially soluble material(s) via a solvent according to various embodiments. FIG. 6A is a simplified isometric view diagram of the modular system 100B configuration 100F. FIG. 6B is a simplified isometric cross-sectional view diagram of the modular system 100B configuration 100F. FIG. 6C is a simplified isometric exploded view diagram of the modular system 100B configuration 100F.

As shown in FIGS. 6A-6C, configuration 100F includes the main body 110, both filters 140, 170, the support 130, and O-rings 180A-C. To form this configuration 100E, one of the filters 140, 170 and then the ring 180A may be inserted into the cylindrical section 114 of the main body 110. Solute material may be inserted into the chamber 5 formed by the filter 140, O-ring 180A, filter 170, and O-ring 180B. In an embodiment, the O-rings 180A-B may not be employed in the configuration 100F as the solute material placed between the filters 140, 170 hold their positions in the main body extension 114.

A solvent may then be poured into the opening 6 to allow the solvent to pass into the chamber 5 via a filter 140, 170, engage the solute material and exit as solution via the second filter 140, 170. This configuration may be used to produce Vietnamese coffee or others. The larger pore filter 140 may be placed at the top of bottom of the configuration 100F as a function of the coffee ground size and time solvent is to engage the grounds in an embodiment. As shown in FIG. 6D configuration 100J, a lid component 120 may be used in a configuration to maintain or extend the temperature of solvent inserted in the main body 110, including for example, configuration 100F shown in FIGS. 6A-6C.

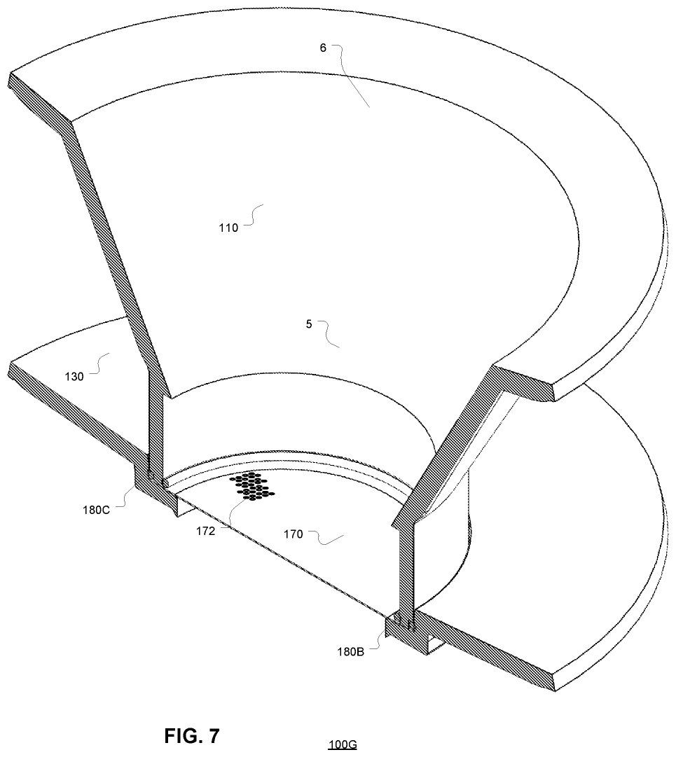

Other configurations of the module system 100B are possible. For example, FIG. 7 is a simplified isometric cross-sectional view diagram of the modular system 100B configuration 100G with various components coupled together to enable methods to produce consumable extractions from at least partially soluble material(s) via a solvent according to various embodiments. In configuration 100G, a filter 170 or 140 is inserted in the bottom of the main body 110. Such a configuration may be used to filter the combination of solute material, solvent, and solutions. For example, configuration 100G may be used to filter mixed drinks.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus, the following claims are hereby incorporated into the Detailed Description, with each claim standing on its own as a separate embodiment.

What is claimed is:

1. A personal beverage generation system, the system including:
a main body having a central axis, an upper conically shaped section having a first length along the central axis and coupled to a lower cylindrically shaped section along the central axis, the lower cylindrically shaped section having a second length, the lower section having an outer first diameter and an inner second diameter, and an opening extending along the central axis from the upper section to the lower section;
a support, the support having a central axis, a third outer diameter, an opening aligned with the central axis and an inset aligned and offset from the opening, the inset having a third diameter about the same as the second diameter so a distal end of the lower section can be nested securely within the support inset; and
a first plurality of components sized to nest within one of the main body and the support;
wherein a second, smaller plurality of components the first plurality of components are coupled with one of the main body and the support to produce a first configuration for generating a beverage from one of a solution and a solvent and a solute material; and
wherein a third, different smaller plurality of components the first plurality of components are coupled with one of the main body and the support to produce a second configuration for generating a beverage from one of a solution and a solvent and a solute material.

2. The personal beverage generation system according to claim 1, wherein one of second, smaller plurality of components and the third, different smaller plurality of components includes a filter having a plurality of openings, the openings sized to prevent solute material from passing therethrough.

3. The personal beverage generation system according to claim 2, wherein the filter having a plurality of openings is reusable.

4. The personal beverage generation system according to claim 1, wherein the filter is formed of metal.

5. The personal beverage generation system according to claim 1, wherein the support has an outer diameter greater than a circular beverage container and is shaped to rest securely on the circular beverage container.

6. The personal beverage generation system according to claim 1, wherein one of second, smaller plurality of components and the third, different smaller plurality of components enables a conical filter to nest therein.

7. The personal beverage generation system according to claim 6, wherein the conical filter has a height of 8.5 cm and a width of 11.5 cm.

8. The personal beverage generation system according to claim 6, wherein the conical filter is sized to enable the production of beverage for a single user.

9. The personal beverage generation system according to claim 1, wherein one of second, smaller plurality of components and the third, different smaller plurality of components enables a conical flat-bottomed filter to nest therein.

10. The personal beverage generation system according to claim 9, wherein the conical flat-bottomed filter is sized to enable the production of beverage for a single user.

11. The personal beverage generation system according to claim 1, wherein one of second, smaller plurality of components and the third, different smaller plurality of components includes a filter having a first plurality of openings, the openings sized to prevent solute material from passing therethrough and the filter is located in the main body lower section.

12. The personal beverage generation system according to claim 11, wherein one of second, smaller plurality of components and the third, different smaller plurality of components includes a second filter having a second plurality of openings, the openings sized to prevent solute material from passing therethrough and the second filter is located in the main body lower section at a location offset from the first filter thereby forming a cavity wherein solute material can be stored and retained via solvent is passed through the main body upper section into the main body lower section.

13. The personal beverage generation system according to claim 11, wherein the first plurality openings is less than the second plurality of openings.

14. The personal beverage generation system according to claim 2, wherein one of second, smaller plurality of components and the third, different smaller plurality of components enables a conical filter to nest therein.

15. The personal beverage generation system according to claim 14, wherein the conical filter has a height of 8.5 cm and a width of 11.5 cm.

16. The personal beverage generation system according to claim 14, wherein the conical filter is sized to enable the production of beverage for a single user.

17. The personal beverage generation system according to claim 6, wherein one of second, smaller plurality of components and the third, different smaller plurality of components includes a filter having a first plurality of openings having a first size, the openings sized to prevent solute material from passing therethrough and the filter is located in the main body lower section.

18. The personal beverage generation system according to claim 17, wherein one of second, smaller plurality of components and the third, different smaller plurality of components includes a second filter having a second plurality of openings having a second size, the openings sized to prevent solute material from passing therethrough and the second filter is located in the main body lower section at a location offset from the first filter thereby forming a cavity wherein solute material can be stored and retained via solvent is passed through the main body upper section into the main body lower section.

19. The personal beverage generation system according to claim 18, wherein the first plurality openings is less than the second plurality of openings.

20. The personal beverage generation system according to claim 19, wherein the first size is greater than the second size.
